(19) United States
(12) Patent Application Publication
(10) Pub. No.: US 2015/0331994 A1
(43) Pub. Date: Nov. 19, 2015

(54) VISUALIZATION OF NUCLEIC ACID SEQUENCES

(71) Applicant: Dali ZHENG, Sunnyvale, CA (US)

(72) Inventor: Dali ZHENG, Sunnyvale, CA (US)

(21) Appl. No.: 14/763,103

(22) PCT Filed: Jan. 24, 2014
(86) PCT No.: PCT/US2014/013031

§ 371 Date: Jul. 23, 2015

Related U.S. Application Data
(60) Provisional application No. 61/757,007, filed on Jan. 25, 2013.

(51) Int. Cl. G06F 19/26

(52) U.S. Cl. CPC G06F 19/26

(57) ABSTRACT

A system and process are provided for analyzing nucleic acid data. An example process can include receiving nucleic acid data including a set of sequence data. The nucleotides of the sequence data can be assigned numerical values. Using these assigned values, partial sums can be calculated for each position in the set of sequence data. The resulting sums can then be displayed in form of Charts or Maps which is so called sequence spectrum to make it easy to navigate and analyze the whole data set. In some examples, patterns or similar/identical sequence segments can be identified within a single set of sequence data or between different sets of sequence data in the spectrum.

This application claims the benefit of and priority to U.S. Provisional Application Ser. No. 61/757,007, filed Jan. 25, 2013, the disclosure of which is hereby incorporated by reference in its entirety.

### BACKGROUND

1. Field

This disclosure relates generally to computer-aided analysis of bioinformatics data and, more specifically, to computer-aided analysis of nucleic acid sequences.

2. Related Art

Deoxyribonucleic acid (DNA) molecule contains the genetic code used in the development and functioning of living organisms. These instructions are encoded in two anti-parallel strands of nucleotides that make up the DNA molecule. Specifically, the instructions are stored in the nucleotides as a chain of four different nucleotides (adenine (A), cytosine (C), guanine (G), and thymine (T)). The specific sequence of the nucleotides defines all physical characteristics of the organism.

To better understand how DNA sequences affect living organisms, a process called DNA sequencing has been developed in which the sequences of nucleotides are read and stored. These sequences can then be analyzed to identify relationships between certain sequences of nucleotides and the resulting physical characteristic in an organism. This technology has a wide range of applications, such as in the fields of diagnostics, biotechnology, forensic biology, biological systematics, and the like.

While processes have been developed to sequence DNA, analysis of the resulting sequences is difficult due to the nature of data contained within a DNA sequence. For example, it is difficult for a scientist to view a long chain of A, T, C, and G nucleotides and extract the information that it represents. Additionally, the large volume of data contained within a DNA sequence makes the sequence analysis a burdensome task. For example, a complete set of human DNA molecules includes 3.3 billions of base pairs. Analysis of data of this magnitude is extremely difficult and time-consuming. And even more difficult is that there is currently no effective way if observing and comparing different species on macroscopic DNA sequence analysis level.

All references cited herein are incorporated by reference in their entireties.

### SUMMARY OF THE INVENTION

The present application provides methods (such as computer-implemented methods, including systems and processes) for analyzing nucleic acid data. An exemplary method includes receiving a nucleotide sequence. Individual nucleobases within the nucleotide sequence are assigned numerical values. Using these assigned values, sums can be calculated for each position within the nucleotide sequence. The resulting sums can then be displayed in various ways, for example in the form of curves (also termed as “sequence spectra”).

The methods provided herein allow ready analyses of a large amount of sequence information. By visually displaying the nucleotide sequence data in the form of curves (“sequence spectra”), one can readily identify characteristic curve patterns (such as peaks and/or peak clusters) that correspond to a particular nucleotide sequence, i.e., a sequence of particular nucleotide combination. By way of example, the rise of the curve in some embodiments correlates (and reflects) the density of AG contained within the nucleotide sequence. The fall of the curve in some embodiments correlates (and reflects) the density of TC contained within the nucleotide sequence. The sequence spectra thus in some embodiments allow one to visually determine the relative AG or TC contents within a specific portion of the nucleotide sequence. These curve patterns can be further labeled or annotated, showing a featured sequence map (e.g. gene, tRNA, rRNA, Alu, repeat sequences, SNP, Methylation etc. Distribution Map) on top of the sequence spectra to provide more informative display. The present application further provides methods of associating one or more portions of the sequence spectrum with a name (i.e., naming a portion of the sequence spectrum), for example for easy identification of a portion of the nucleotide sequence having a characteristic sequence pattern.

The methods provided herein also allow ready identification of sequence similarities among large chunks of nucleotide sequences (for example different chromosomes). By comparing the different sequence spectra and searching for curve patterns with same or similar shapes, one can readily identify regions within different nucleotide sequences that share sequence similarities. This makes it possible to readily compare different sets of nucleotide sequences especially nucleotide sequences of large sizes, for example, chromosomal sequences, and identify sequence similarities among those sequences.

The methods provided herein can also be used to find large chunks of sequence repeats within a given nucleotide sequence, for example by comparing different portions of the same sequence spectrum. This allows one to readily identify repeat sequences within a given nucleotide sequence. This also allows one to conduct quality control for a sequencing project (for example a genome sequencing project) which involves assembly of a large amount of sequence information. By determining the occurrence and frequency of artificial sequence repeats within a single nucleotide sequence, one would be able to assess the occurrence and frequency of sequence artifacts during the sequencing project and evaluate the quality of the sequencing data.

Thus, the present invention in one aspect provides a method (such as a computer-implemented method) for generating a visual representation (for example a sequence spectrum) of a nucleotide sequence. In another aspect, there are provided methods of analyzing nucleotide sequences (for example nucleotide sequences in the size range of at least about 0.01, 0.1, 1, 10 or 100 megabases). In another aspect, there are provided methods of visually displaying nucleotide sequences (for example nucleotide sequences in the size range of at least about 0.01, 0.1, 1, 10 or 100, megabases). In another aspect, there are provided methods of comparing nucleotide sequences (for example nucleotide sequences in the size range of at least about 0.01, 0.1, 1, 10 or 100 megabase). In another aspect, there are provided methods of identifying sequence repeats (for example sequence repeats in the size range of at least about 1, 10, 100, or 1000 kilobases) within a given nucleotide sequence. Also provided are systems for carrying out the computer-implemented methods described herein.

Thus, for example, in some embodiments, there is provided a computer-implemented method for generating a visual representation of nucleic acid data, the method comprising: (a) receiving a first sequence of nucleotides; (b) assigning values to the nucleotides of the first sequence of nucleotides to generate a first series of nucleotide values; (c) generating a first set of summation data for the first sequence of nucleotides using the first series of nucleotide values; and (d) causing a display of a visual representation of the first set of summation data. In some embodiments, the first sequence of nucleotides comprises a plurality of nucleotides comprising adenine, thymine, guanine, and cytosine. In some embodiments, each of the adenine nucleotides of the first sequence of nucleotides are assigned the same value in the first series of nucleotide values; each of the thymine nucleotides of the first sequence of nucleotides are assigned the same value in the first series of nucleotide values; each of the guanine nucleotides of the first sequence of nucleotides are assigned the same value in the first series of nucleotide values; and each of the cytosine nucleotides of the first sequence of nucleotides are assigned the same value in the first series of nucleotide values;

In some embodiments according to any of the embodiments above, the values assigned to the adenine nucleotides of the first sequence of nucleotides and the values assigned to the thymine nucleotides of the first sequence of nucleotides are additive inverses, and wherein the values assigned to the guanine nucleotides of the first sequence of nucleotides and the values assigned to the cytosine nucleotides of the first sequence of nucleotides are additive inverses.

In some embodiments according to any of the embodiments above, the visual representation of the first set of summation data comprises a graph representation of the summation data.

In some embodiments according to any of the embodiments above, the first set of summation data comprises a plurality of partial sums calculated using first series of nucleotide values.

In some embodiments according to any of the embodiments above, the method further comprises: generating a copy of at least a portion of the visual representation of the first set of summation data; and causing a display of the copy of the at least a portion of the visual representation of the first set of summation data.

In some embodiments according to any of the embodiments above, the display of the copy comprises a reflected or rotated representation of the portion of the at least a portion of the visual representation of the first set of summation data.

In some embodiments according to any of the embodiments above, wherein the method further comprises causing a display of an annotation of featured sequences associated with a nucleotide of the first sequence of nucleotides.

In some embodiments according to any of the embodiments above, wherein the method further comprises identifying identical sections of the first set of summation data.

In some embodiments according to any of the embodiments above, wherein the method further comprises identifying symmetry between sections of the first set of summation data.

In some embodiments according to any of the embodiments above, wherein the method further comprises receiving a second sequence of nucleotides; assigning values to the nucleotides of second sequence of nucleotides to generate a second series of nucleotide values; generating a second set of summation data for the second sequence of nucleotides using the second series of nucleotide values; and causing a display of a visual representation of the second set of summation data. In some embodiments, nucleotides of the second sequence of nucleotides are assigned the same value as similar nucleotides of the first series of nucleotides. In some embodiments, the method further comprises identifying similar or symmetry between a section of the first set of summation data and a section of the second set of summation data.

In some embodiments, there is provided a visual representation generated by any one of the methods described above.

In some embodiments, there is provided a method of naming a portion of a visual representation of nucleic acid data, wherein the visual representation is generated by a method comprising: (a) receiving a first sequence of nucleotides; (b) assigning values to the nucleotides of the first sequence of nucleotides to generate a first series of nucleotide values; (c) generating a first set of summation data for the first sequence of nucleotides using the first series of nucleotide values; and (d) causing a display of a visual representation of the first set of summation data.

### BRIEF DESCRIPTION OF THE DRAWINGS

FIG. 1 illustrates an exemplary process for analyzing nucleic acid sequence data according to various examples.

FIG. 2 illustrates an exemplary display of Schematic Diagram of Visualizing nucleic acid sequence data.

FIG. 3 illustrates an exemplary display of nucleic acid sequence spectra showing symmetric patterns of a single nucleic acid sequence in different reading direction.

FIG. 4 illustrates an exemplary display of Sequence spectra of a mouse's chromosome 1 drawn by using different parameter sets

FIG. 5 illustrates an exemplary display of nucleic acid sequence spectra at various levels of zoom.

FIG. 6 illustrates an exemplary display of Human's 23-chromosome sequence spectra.

FIG. 7 illustrates an exemplary display of nucleic acid sequence spectrum showing symmetry between portions of a single sequence of nucleotides and comparing with the same set of chromosomal sequence of HuRef.

FIG. 8 illustrates an exemplary display of nucleic acid sequence spectra showing symmetric relationship between portions of different species' sequences of nucleotides.

FIG. 9 illustrates an exemplary display of nucleic acid sequence spectrum showing distribution of genes and tRNAs on mtDNA with annotations.

FIG. 10 illustrates an exemplary computing system that may be employed to implement processing functionality for various aspects of the present disclosure.

### DETAILED DESCRIPTION

The present application provides methods (such as computer-implemented methods, including systems and processes) for analyzing nucleic acid data. An exemplary method includes receiving a nucleotide sequence. Individual nucleobases within the nucleotide sequence are assigned numerical values. Using these assigned values, sums can be calculated for each position within the nucleotide sequence. The resulting sums can then be displayed in various ways, for example in the form of curves (also termed as “sequence spectra”).

The methods provided herein allow ready analyses of a large amount of sequence information. By visually displaying the nucleotide sequence data in the form of curves (“sequence spectra”), one can readily identify characteristic curve patterns (such as peaks and/or peak clusters) that correspond to a particular nucleotide sequence, i.e., a sequence of particular nucleotide combination. By way of example, the rise of the curve in some embodiments correlates (and reflects) the density of AG contained within the nucleotide sequence. The fall of the curve in some embodiments correlates (and reflects) the density of TC contained within the nucleotide sequence. The sequence spectra thus in some embodiments allow one to visually determine the relative AG or TC contents within a specific portion of the nucleotide sequence. These curve patterns can be further labeled or annotated, showing a featured map (e.g. gene, tRNA, rRNA, Alu, repeat sequences, SNP, Methylation etc. Distribution Map) on top of the sequence spectra to provide more informative display. The present application further provides methods of associating one or more portions of the sequence spectrum with a name (i.e., naming a portion of the sequence spectrum), for example for easy identification of a portion of the nucleotide sequence having a characteristic sequence pattern.

The methods provided herein also allow ready identification of sequence similarities among large chunks of nucleotide sequences (for example different chromosomes). By comparing the different sequence spectra and searching for curve patterns with same or similar shapes, one can readily identify regions within different nucleotide sequences that share sequence similarities. This makes it possible to readily compare different sets of nucleotide sequences especially nucleotide sequences of large sizes, for example, chromosomal sequences, and identify sequence similarities among those sequences.

The methods provided herein can also be used to find large chunks of sequence repeats within a given nucleotide sequence, for example by comparing different portions of the same sequence spectrum. This allows one to readily identify repeat sequences within a given nucleotide sequence. This also allows one to conduct quality control for a sequencing project (for example a genome sequencing project) which involves assembly of a large amount of sequence information. By determining the occurrence and frequency of artificial sequence repeats within a single nucleotide sequence, one would be able to assess the occurrence and frequency of sequence artifacts during the sequencing project and evaluate the quality of the sequencing data.

Thus, the present invention in one aspect provides a method (such as a computer-implemented method) for generating a visual representation (for example a sequence spectrum) of a nucleotide sequence. In another aspect, there are provided methods of analyzing nucleotide sequences (for example nucleotide sequences in the size range of at least about 0.01, 0.1, 1, 10 or 100 megabases). In another aspect, there are provided methods of visually displaying nucleotide sequences (for example nucleotide sequences in the size range of at least about 0.01, 0.1, 1, 10 or 100, megabases). In another aspect, there are provided methods of comparing nucleotide sequences (for example nucleotide sequences in the size range of at least about 0.01, 0.1, 1, 10 or 100 megabase). In another aspect, there are provided methods of identifying sequence repeats (for example sequence repeats in the size range of at least about 1, 10, 100, or 1000 kilobases) within a given nucleotide sequence. Also provided are systems for carrying out the computer-implemented methods described herein.

In the following description of exemplary embodiments, reference is made to the accompanying drawings which form a part hereof, and in which it is shown by way of illustration specific embodiments in which the present disclosure can be practiced. It is to be understood that other embodiments can be used and structural changes can be made without departing from the scope of the various embodiments.

A system and process are provided for analyzing nucleic acid data. An example process can include receiving nucleic acid data including a set of sequence data. The nucleotides of the sequence data can be assigned numerical values. Using these assigned values, full or partial sums can be calculated for each position in the set of sequence data. The resulting sums can then be displayed in various ways to analyze the data. In some examples, patterns or similar/identical (redundancy) sequence segments can be identified within a single set of sequence data or between different sets of sequence data.

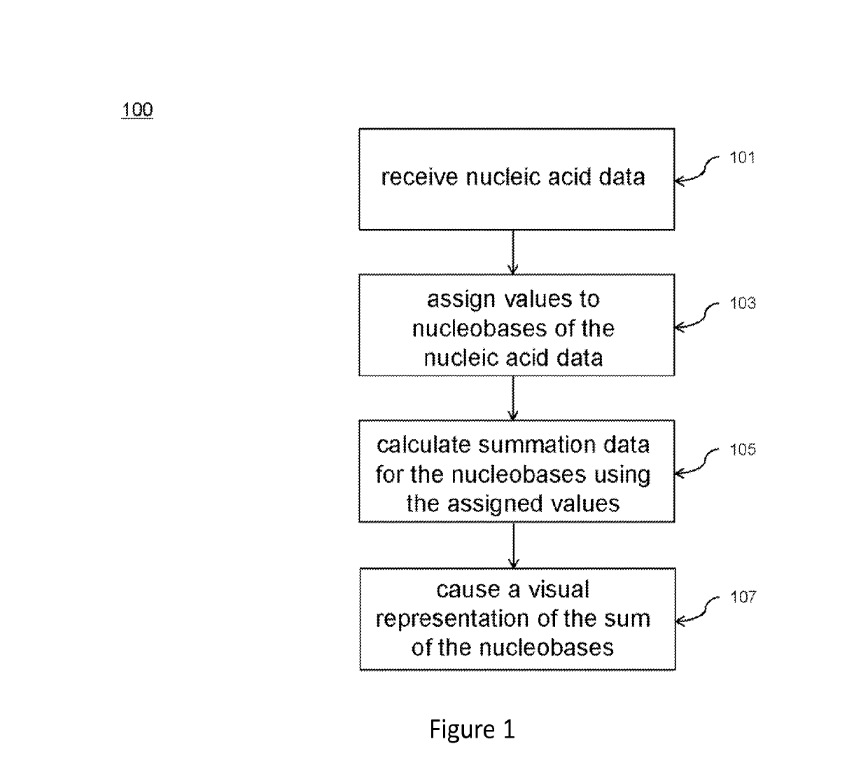

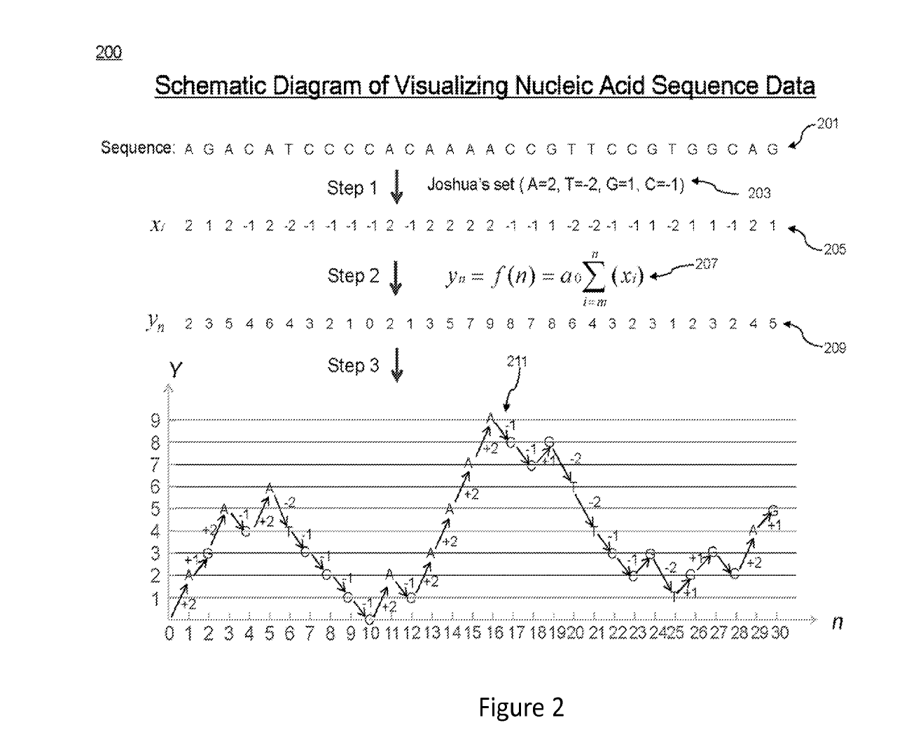

FIG. 1 illustrates an exemplary process 100 for analyzing nucleic acid data. Process 100 can be used to generate visual representations of a nucleic acid sequence, such as that shown in FIGS. 2-8. At block 101, nucleic acid sequence data can be received. The nucleic acid data can include an ordered sequence of nucleotides (e.g., A, uracil (U) or T, C, and G) contained in one or more nucleic acid chains and can represent, for example, DNA, ribonucleic acid (RNA), or the like. The nucleic acid data can be accessed or received from a local or remote database. (FIG. 2-201)

At block 103, numerical values can be assigned to the nucleotides of the nucleic acid data received at block 101. In some examples, base pairs that are complementary to each other in a DNA double helix can be assigned values that are additive inverses of each other. For instance, since A is a complementary base pair of T in a DNA double helix and C is a complementary base pair of G in a DNA double helix, the following number assignments can be used: A=k, T=−k, G=q, and C=−q, where k and q are not equal to zero simultaneously. Additionally, in some examples, the sign (+/−) of the value assigned to A may be equal to the sign (+/−) of the value assigned to G and the sign (+/−) of the value assigned to T may be equal to the sign (+/−) of the value assigned to C. To illustrate, the sequence of nucleotides (AGACATCCCCACAAAACCGTTCCGTGGCAG) can be converted into a series of nucleotide values (x), where x=(2, 1, 2, −1, 2, −2, −1, −1, −1, 2, −1, 2, 2, 2, 2, −1, −1, 1, −2, −2, −1, −1, 1, −2, 1, 1, −1, 2, 1)(FIG. 2-205) when using assigned a set of values of A=2, T=−2, G=1, and C=−1 (FIG. 2-203 Joshua's set).

At block 105, summation data can be calculated for the nucleic acid data received at block 101 using the ordered series of nucleotide values (x) generated at block 103. In some examples, the summation data can be calculated using equation 1.1, shown below.

$${y}_{n} = f ( n ) = {a}_{0} {\sum }_{i = m}^{n} ( {x}_{i} ) \qquad 1.1$$

In equation 1.1, “i” represents the index of summation, x, represents the i^{th} number in the series of nucleotide values (x), “m” represents the lower bound value of “i” in the summation, “n” equals the upper bound value of “i” in the summation, and aₒ is a constant. In some examples, “m” may be selected to have a value of 1. As a result, the sequence of partial sums yₙ may include partial sums using all values of the series of nucleotide values (x).

In other examples, “m” may be selected using the following equation: m=n−(C−1), where C is a desired window size. However, if m<1 using this equation, then m may be given a value of 1. In these examples, C may be selected to produce partial sums that are calculated using the previous C values of the series of nucleotide values (x).

The value of aₒ may be selected to adjust the values of the sequence of partial sums relative to the index “i” values. For example, as described below with respect to block 107, the sequence of partial sums yₙ may be displayed in graphical format with the y-coordinates of the graph corresponding to the values of the sequence of partial sums yₙ and the x-coordinates of the graph corresponding to the index “i” values. Thus, increasing the value of aₒ may vertically stretch the graph, while decreasing the value of aₒ may vertically compress the graph. This may be used to provide various levels of zoom when viewing the graph.

Applying equation 1.1 to the example series of nucleotide values x=(2, 1, 2, −1, 2, −2, −1, −1, −1, 2, −1, 2, 2, 2, 2, −1, −1, 1, −2, −2, −1, −1, 1, −2, 1, 1, −1, 2, 1) (FIG. 2-205) discussed above and using m=1, the sequence of nucleotide partial sum values y=(2, 3, 5, 4, 6, 4, 3, 2, 1, 0, 2, 1, 3, 5, 7, 9, 8, 7, 8, 6, 4, 3, 2, 3, 1, 2, 3, 2, 4, 5) (FIG. 2-207). It should be appreciated that the values described above are provided as an example, and that actual nucleic acid data can include a larger number of nucleotides and the values assigned to the nucleotides can be different.

At block 107, a visual representation of the summation data (e.g., nucleobase partial sum values y) generated at block 105 can be displayed. In some examples, the summation data can be displayed in graphical form. By displaying a graphical representation of the nucleic acid sequence data, a user can quickly identify patterns in the data. FIGS. 2-209 illustrate example displays of the summation data.

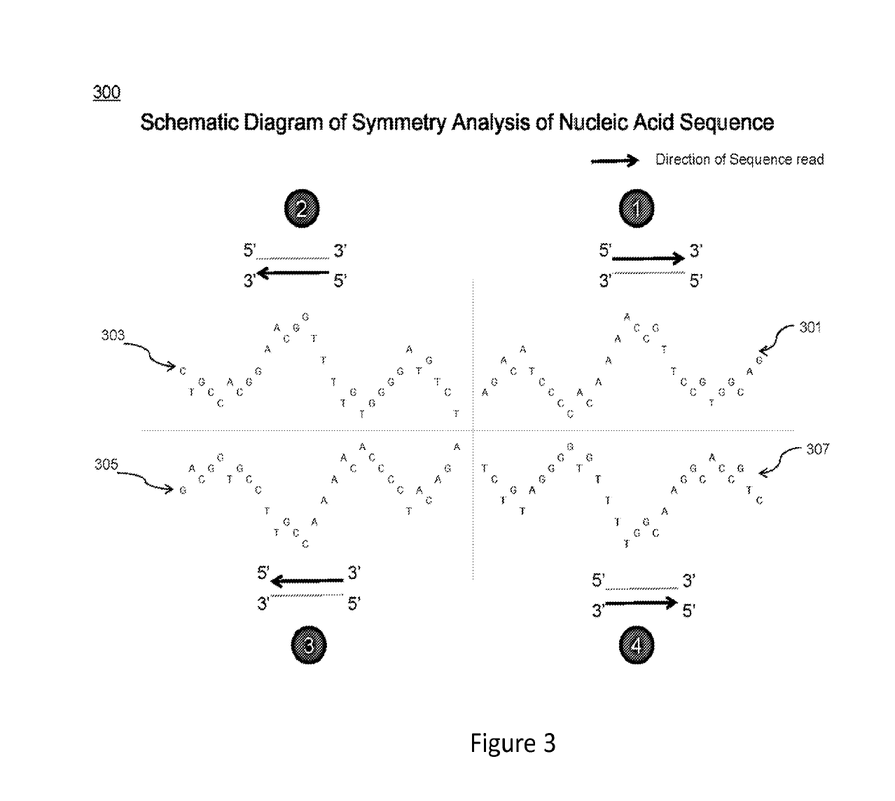

To illustrate, FIG. 3 shows an exemplary display 300 showing three different types of symmetry that can be identified between the same set of sequence data with different reading directions. Display 300 may include a first view 301 for displaying a visual representation of the sequence data (x) shown in FIG. 2. This view 301 represents the sequence data read in the 5′ to 3′ direction. The data shown in first view 301 can be compared to a second set of sequence data shown in second view 303. This second view 303 represents the second set of sequence data read in the 5′ to 3′ direction which is complementary sequence to the first one. As can be seen in FIG. 3, the first set of sequence data shown in first view 301 is reflectionally symmetric across the y-axis with the second set of sequence data shown in second view 303. This type of symmetry can indicate that the first set of sequence data shown in first view 301 and the second set of sequence data shown in second view 303 are complementary strands from the same sequence.

Display 300 further includes a third view 305 for displaying a third set of sequence data. This third view 305 represents the third set of sequence data read in the 3′ to 5′ direction of the first sequence. As can be seen in FIG. 3, the first set of sequence data shown in first view 301 is 180° rotationally symmetric with the third set of sequence data shown in third view 305. This type of symmetry indicates that the first set of sequence data shown in first view 301 and the third set of sequence data shown in third view 305 are the same strand of nucleotides, but have been sequenced in different directions.

Display 300 further includes a fourth view 307 for displaying a fourth set of sequence data. This fourth view 307 represents the fourth set of sequence data read in the 3′ to 5′ direction which is complementary sequence to the first one. As can be seen in FIG. 3, the first set of sequence data shown in first view 301 is reflectionally symmetric across the x-axis with the fourth set of sequence data shown in fourth view 307. This type of symmetry indicates that the first set of sequence data shown in first view 301 and the fourth set of sequence data shown in fourth view 307 are complementary strands from the same sequence, but that the strands have been sequenced from opposite ends (e.g., 3′ to 5′ and 5′ to 3′ directions).

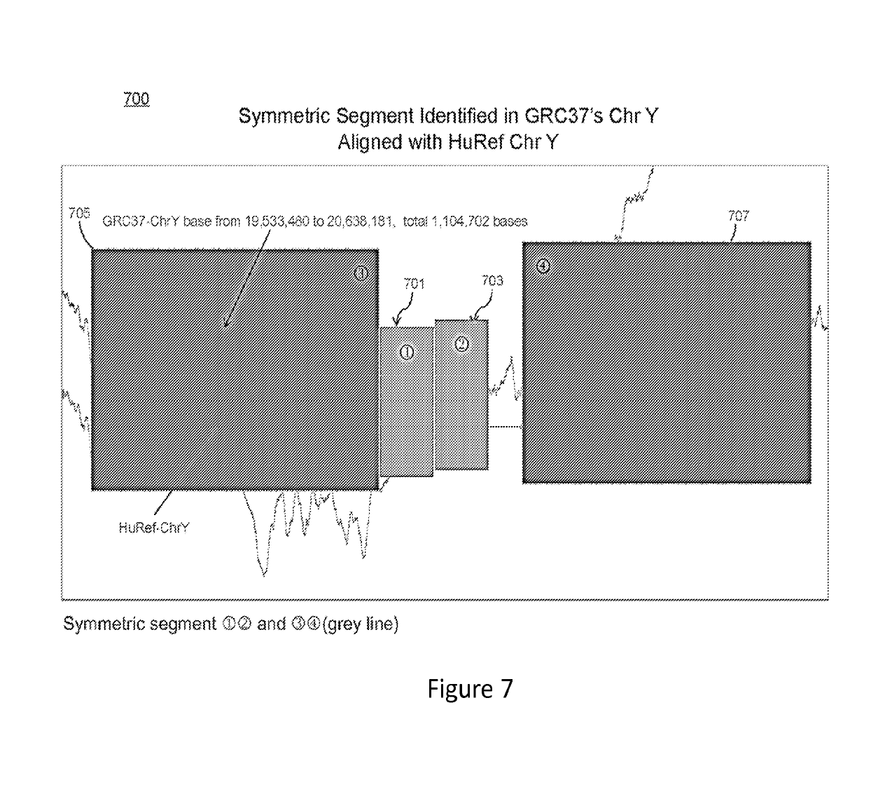

It should be appreciated that in addition to identifying symmetry between sections of different strands (e.g., as shown in FIGS. 3, 7, and 8), symmetry may also be identified between sections of the same strand (e.g., as shown in FIG. 7). Thus, in addition to identifying sequence sections that are complementary, identical but sequenced in different directions, and complementary but sequenced in different directions, symmetry can be used to identify sequencing errors and/or artifacts.

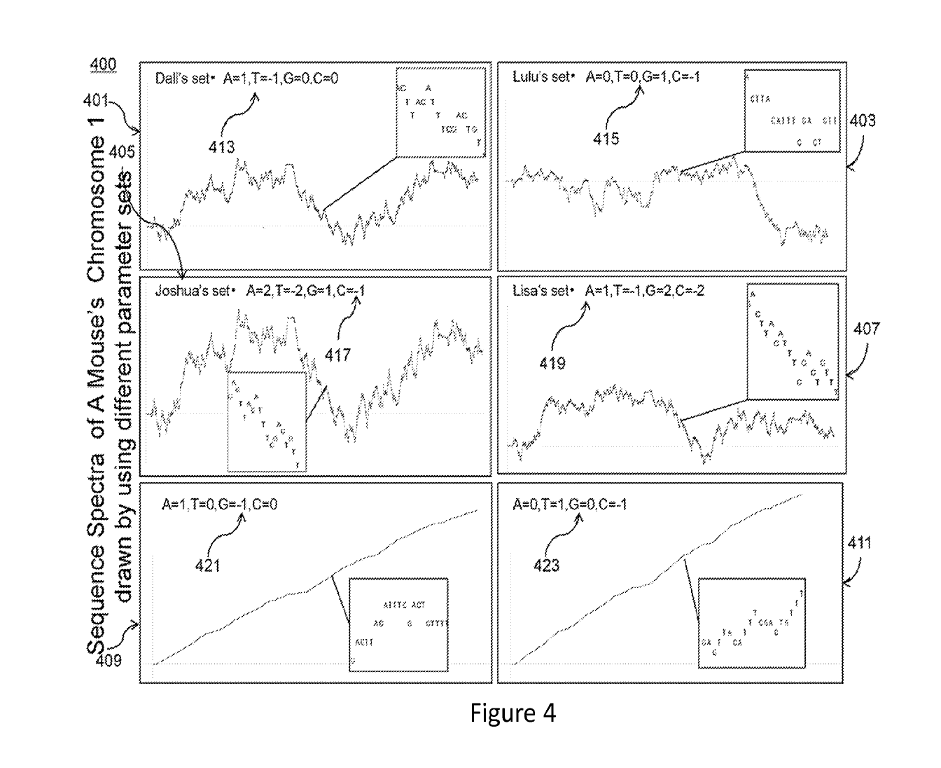

FIG. 4 provides an exemplary display of sequence spectra of mouse chromosome 1 generated by using different parameters. As shown in FIG. 4, the sequence spectra 4-401, 4-405, 4-407 are similar in shape. Among these, sequence spectrum 4-405 generated by using parameters (A=2, T=−2, G=1, C=−1) presents more details in the curve, thus providing more information for curve analyses. Thus, unless otherwise indicated, most sequence spectra provided in the present application use the parameters (A=2, T=−2, G=1, C=−1).

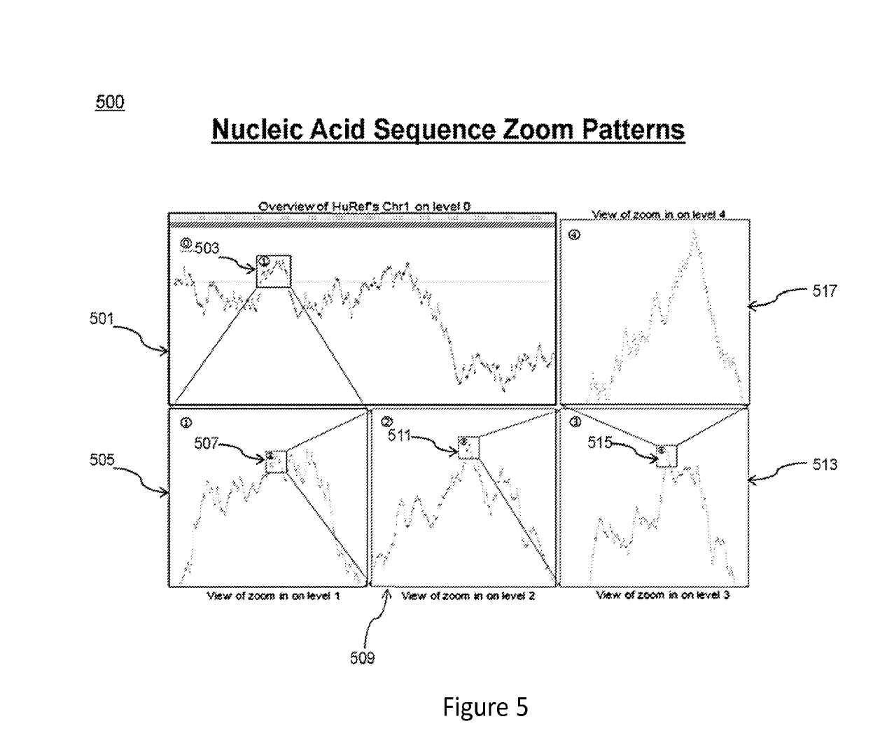

For example, FIG. 5 illustrates an exemplary display 500 of a set of sequence data shown at various levels of zoom. Specifically, first display 501 shows a zoomed-out view of a set of sequence data. A portion 503 of the sequence data may be selected for closer inspection, causing a zoomed-in view of portion 503 to be displayed within second display 505. In other words, second display 503 includes only portion 503 of the sequence data shown in first display 501. Similarly, a portion 507 of the sequence data shown in second display 505 may be selected for closer inspection, causing a zoomed-in view of portion 507 to be displayed within third display 509. Third display 509 includes only portion 507 of the sequence data shown in second display 505. Similarly, a portion 511 of the sequence data shown in third display 509 may be selected for closer inspection, causing a zoomed-in view of portion 511 to be displayed within fourth display 513. Fourth display 513 includes only portion 511 of the sequence data shown in third display 509. This zooming-in process may be continued by selecting a portion 515 of the sequence data shown in fourth display 513 for closer inspection, causing a zoomed-in view of portion 515 to be displayed within fifth display 517. Fifth display 517 includes only portion 515 of the sequence data shown in fourth display 513. It should be appreciated that this process may be continued until reaching a desired level of zoom. Similarly, the displays may be zoomed-out to cause a display of displays 501, 505, 509, 513, and 517 in the opposite order. In some examples, the visual representation of the sequence data can be varied based on the level of zoom. For example, when zoomed-out, as shown in first display 501, the sequence data may be displayed as a line. If zoomed-in, as shown in fifth display 517, the sequence data may be displayed as dots. If zoomed-in further, the sequence data may be displayed as letters corresponding to the different nucleotides, such as that shown in FIGS. 2 and 3. The zoom levels at which the visual representations of the sequence data changes from one type to another can be selected based on screen resolution, amount of data displayed, and the like.

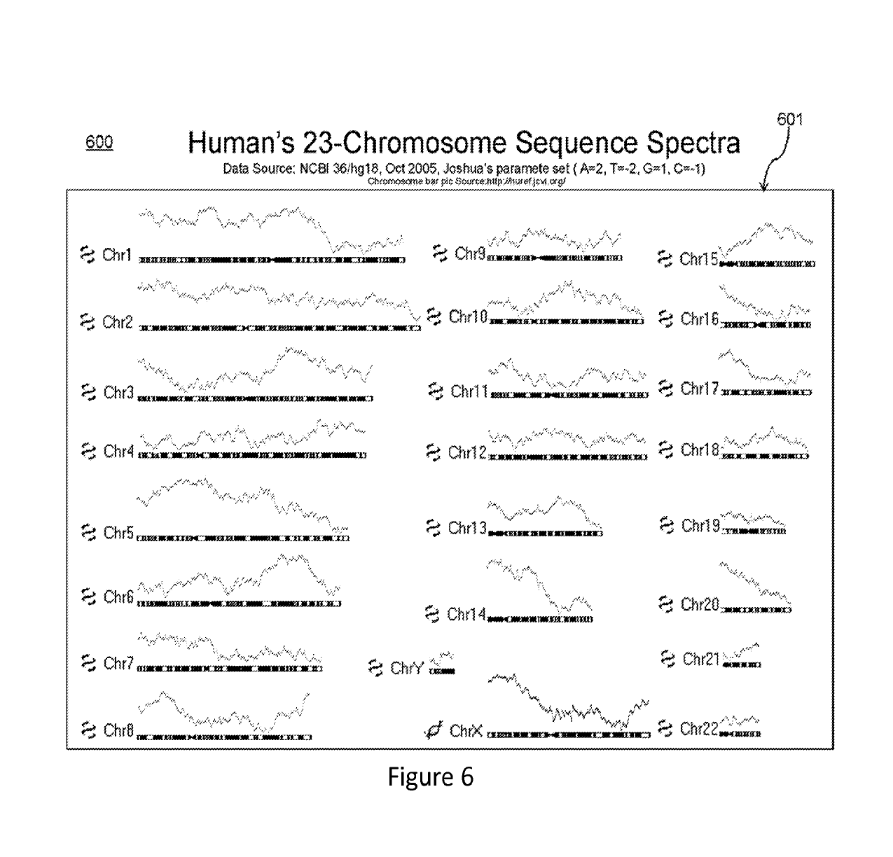

FIG. 6 illustrates another exemplary display 600 showing a set of sequence spectra of the 23 human chromosomes. As demonstrated in FIG. 6, each of the 23 human chromosome can be visually represented by a characteristic sequence curve (spectrum). The present application thus in some embodiments provides one or more sequence spectra as shown in FIG. 6.

FIG. 7 illustrates another exemplary display 700 showing symmetry between portions of the same set of sequence data. Specifically, first set of sequence data 701 is reflectionally symmetric with second set of sequence data 703. Similarly, third set of sequence data 705 is reflectionally symmetric with fourth set of sequence data 707. This phenomenon might implicate redundancy in the set.

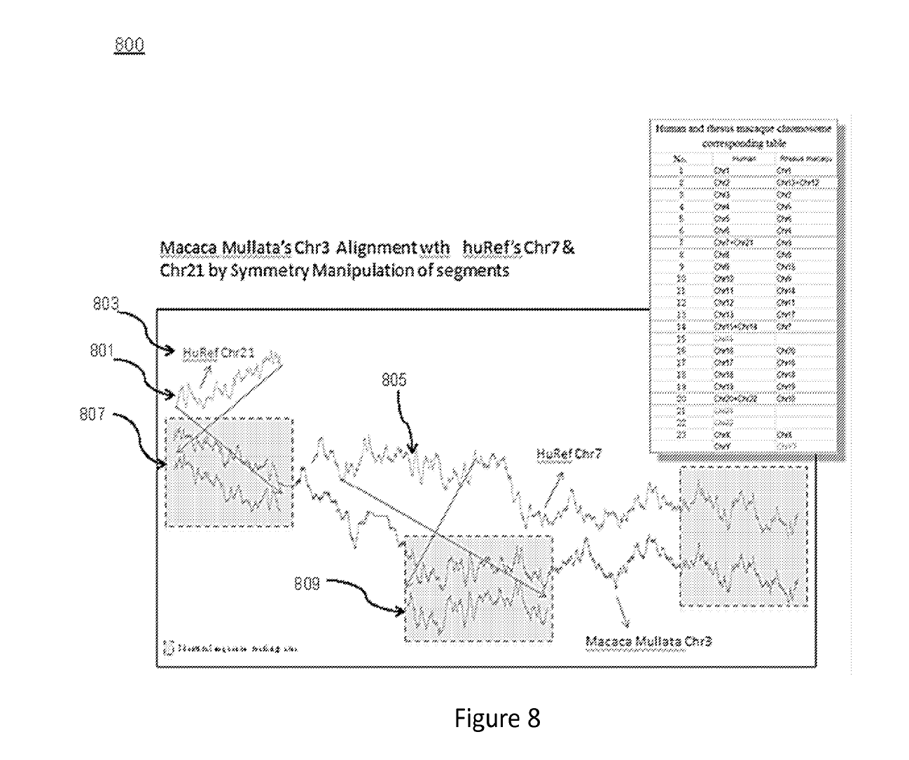

FIG. 8 illustrates another exemplary display 800 for comparing different sets of sequence data. Display 800 includes a first set of sequence data 801 representing monkey reference chromosome #3, second set of sequence data 803 representing human reference chromosome #21, and third set of sequence data 805 representing human reference chromosome #7. In this example, a portion of the second set of sequence data 803 is copied and reflected across the y-axis to generate copy 807. This copy 807 can be compared to the first portion of the first set of sequence data 801. This comparison shows a similar nucleotide sequence profile between the first portion of the first set of sequence data 801 and the second set of sequence data 803. Similarly, a portion of the third set of sequence data 805 can be copied and reflected across the y-axis to generate copy 809. Copy 809 can be compared to a second portion of the first set of sequence data 801 to identify similarities between the sets of data.

In some examples, patterns in the sequence data may be automatically identified. For example, similar portions of sequence data may be identified by analyzing the sequence of nucleotides to identify sections of identical nucleotides. In other examples, reflectionally or rotationally symmetric portions of sequence data may be identified by identifying sections of nucleotides ordered in opposite directions (for rotational symmetry), by identifying complementary sections of nucleotides ordered in the same direction (for reflectional symmetry across the x-axis), and by identifying complementary sections of nucleotides ordered in opposite directions (for reflectional symmetry across the y-axis). In some embodiments, the size of each section to be compared is any of 1, 10, 100, 500, 600, 700, 800, 900, or 1,000 kilobases. In some embodiments, the size of each section to be compared is any of 1, 10, 100, 500, 600, 700, 800, 900, or 1,000 megabases.

In some examples, the sequence spectrum may be annotated or labeled to provide further information to a user about distribution of genes, tRNAs, repeat sequences, SNP, or Methylation etc. The annotation data may be entered by a user or by a standard annotation database from NCBI, EMBL or DDBJ.

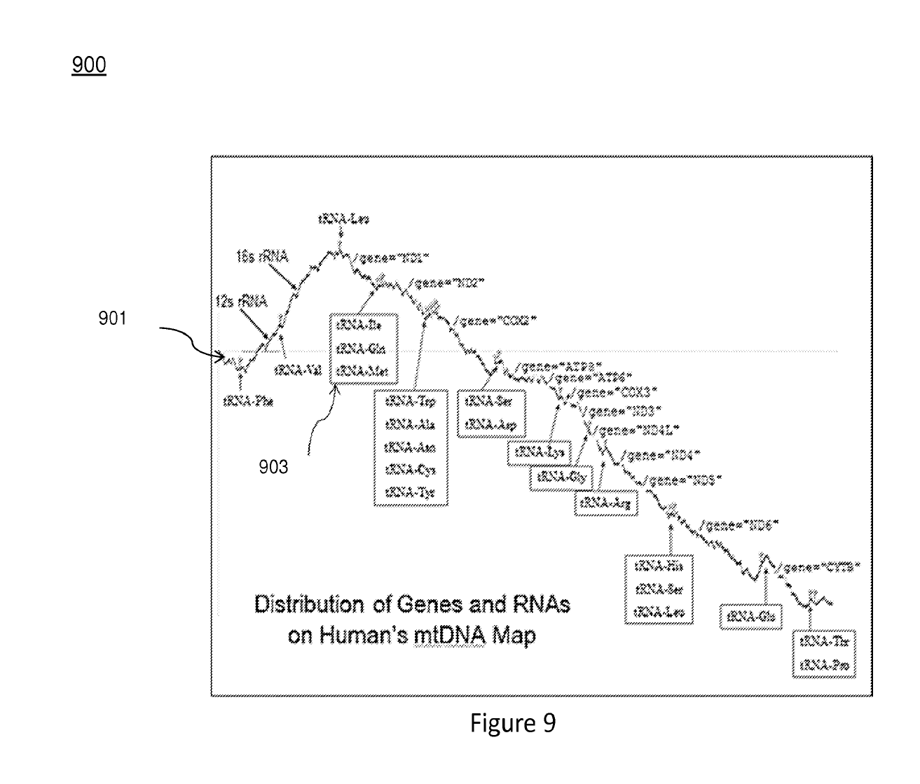

FIG. 9 illustrates an exemplary display 900 showing a set of sequence data 901. The sequence data 901 is annotated at various points by annotation boxes 903 (to avoid clutter, only one annotation box is labeled). The data contained in the annotation boxes 903 may be stored in association with the nucleotide related to the annotation. In some examples, annotations can be created by selecting a nucleotide or portion of the nucleotide sequence (e.g., by clicking the desired portion of the sequence), and entering the desired information. The annotation data may be saved as mentioned above, and may be displayed in subsequent viewings of the sequence data.

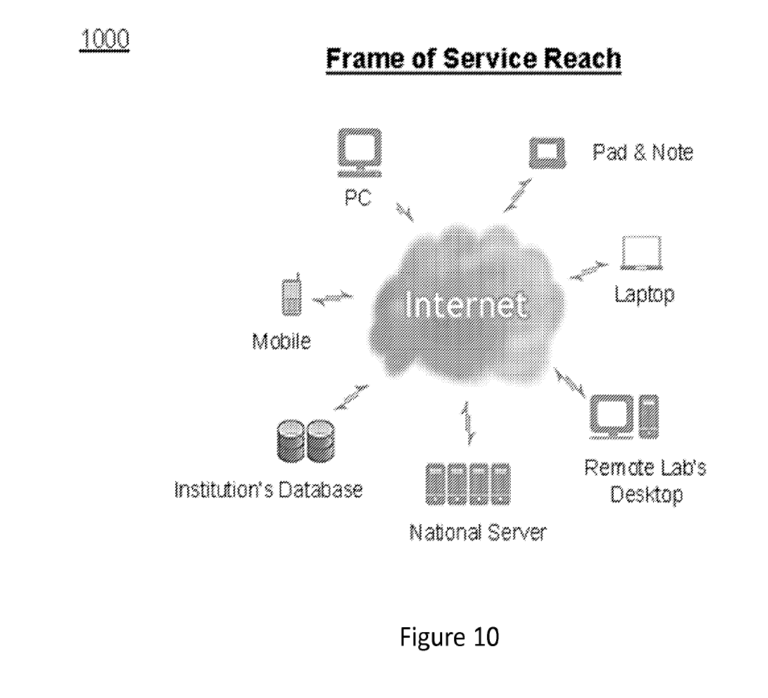

FIG. 10 illustrates an exemplary computing system 1000 that may be employed to implement processing functionality for various aspects of the current technology. The carrier for figure analyses can be the traditional PC or laptop computer, or it can be a mobile device such as tablet or smart phone. Alternative, the carrier can be a mobile device such as a gene detection device, which can detect sequence data from a data source (such as an individual) and transmit the data through the Internet or a database for cloud computing. The data for comparison can also be transmitted through the Internet or a database for cloud computing. The gene spectra described herein requires low graphic data transmission and storage space, involves a relatively small amount of data, and allows easy analyses and interpretation. These advantages make it particularly suitable for mobile end-user devices.

### APPLICATIONS OF THE INVENTIVE METHODS

The methods (such as computer-implemented methods including systems and processes) provided herein can be used to analyze any type of nucleotide sequences. In some embodiments, the nucleotide sequence is DNA, such as genomic DNA. In some embodiments, the nucleotide sequence is RNA, such as mRNA. In some embodiments, the nucleotide sequence is the sequence of an RNA/DNA hybrid. In some embodiments, the nucleotide sequence is the sequence of a chromosome (such as a human chromosome). In some embodiments, the nucleotide sequence is a sequence assembled by linking the sequence of different contigs together.

The methods provided herein allow analyses of an enormous amount of sequence information. By visually displaying the nucleotide sequence data in the form of sequence spectra, one can readily identify characteristic curve patterns (such as peaks and/or peak clusters) that correspond to a particular nucleotide sequence. These curve patterns (such as peaks and/or cluster of peaks) can be further labeled or annotated, providing a more informatic and featured sequence map on top of the sequence spectra. Thus, the present invention in some embodiments provides a method of generating a sequence spectrum for a nucleotide sequence, the method comprising: a) receiving the nucleotide sequence, b) assigning values to each nucleotide within the nucleotide sequence to generate a series of nucleotide values, c) generating a set of summation data for the nucleotide sequence using the series of nucleotide values, and d) causing a display of a visual representation of the set of summation data. In some embodiments, the method further comprises e) labeling the sequence spectrum with featured annotation (e.g. genes RNA, Repeat sequence, SNP, Methylation etc.)

In some embodiments, the method further comprises annotating a portion of the sequence spectra. For example, a database can be provided with schemes of corresponding DNA features and genomic annotation information. The database can incorporate publicly available, proprietary, and other third party information (such as genomic information). Exemplary database include, for example, UCSC Genome Bioinformatics (http://genome.ucsc.edu/), EMBL (http://www.ebi.ac.uk), GenBank (http://www.ncbi.nlm.nih.gov/Genbank), and DDBJ (http://www.ddbj.nig.ac.jp).

In some embodiments, the method further comprises naming a portion of any one of the visual presentation of nucleic acid data discussed herein.

The sequence spectra generated using methods described herein can be further analyzed, for example, to categorize different portions of the sequences into specific classes based on the specific shape of the curve patterns in the queried regions. In some embodiments, the sequence spectra can be analyzed to identify abnormalities within the nucleotide sequence, for example by comparing the sequence spectra generated from the nucleotide sequence of an individual with a reference spectrum. The reference spectrum can be a sequence spectrum based on a normal individual, or a population of normal individuals. In some embodiments, the method comprises compiling multiple sequence spectra together and comparing the spectra simultaneously.

The methods provided herein also allow ready identification of sequence similarities among large chunks of nucleotide sequences (for example different chromosomes). By comparing the curve patterns (such as peaks/cluster of peaks) of different sequence spectra and searching for curve patterns (such as peaks or cluster of peaks) with same or similar shapes, one can readily identify regions within different nucleotide sequences that share sequence similarities. This makes it possible to readily compare different sets of nucleotide sequences, for example, chromosomal sequences from different species, and identify sequence similarities among those sequences. Thus, the present invention in some embodiments provides a method of identifying sequence similarities between two nucleotide sequences (for example two nucleotide sequences of the size of at least any of 0.01, 0.1, 1, 10, or 100 megabases), the method comprising: a) receiving a first nucleotide sequence; b) receiving a second nucleotide sequence; c) assigning values to each nucleotide within the first and second nucleotide sequences to generate a first and a second series of nucleotide values, c) generating a first set of summation data for the nucleotide sequence using the first series of nucleotide values and causing a display of a first visual representation of the first set of summation data; d) generating a second set of summation data for the nucleotide sequence using the second series of nucleotide values and causing a display of a second visual representation of the second set of summation data; e) comparing the first visual representation with the second visual representation, wherein the presence of similar curve patterns (for example peaks or cluster of peaks) between the two visual representations indicate a sequence similarity between the first nucleotide sequence and the second nucleotide sequence. In some embodiments, the first and second nucleotide sequences are of the same origin. In some embodiments, the first and second nucleotide sequences are of difference origin. In some embodiments, the first and second nucleotide sequences are at least about 0.01, 0.1, 1, 10, or 100 megabases. In some embodiments, the first and second nucleotide sequences are both chromosomal sequences. In some embodiments, the first and second nucleotide sequences are DNA. In some embodiments, the first and second nucleotide sequences are RNA. In some embodiments, the first nucleotide sequence is DNA and the second nucleotide sequence is RNA.

The methods provided herein can also be useful for identifying large chunks of sequence repeats within a given nucleotide sequence, for example by comparing the curve patterns at different portions of the same sequence spectra. Identification of sequence repeats within a given sequence may allow one to identify and annotate repeat sequences, such as SINEs (short interspersed nuclear elements), LINEs (long interspersed nuclear elements), LTRs (long terminal repeats), unclassified elements, satellites, simple repeats, and low complexity regions. The methods also allow one to conduct quality control for a sequencing project (for example a genome sequencing project) which involves assembly of a large amount of sequence information. By determining the number of sequence repeats found within a single nucleotide sequence, one can assess the occurrence and/or frequency of sequence artifacts during the sequencing project and evaluate the quality of the sequencing data. Thus, the present invention in some embodiments provides a method of identifying sequence repeats within a nucleotide sequence (for example a nucleotide sequence of the size of at least any of 0.01, 0.1, 1, 10, or 100 megabases), the method comprising: a) receiving the nucleotide sequence; b) assigning values to the nucleotides of the nucleotide sequence to generate a series of nucleotide values; c) generating a set of summation data for the nucleotide sequence using the series of nucleotide values, d) causing a display of a visual representation of the set of summation data; and e) examining the visual representation, wherein the presence of similar curve patterns (such as peaks or cluster of peaks) within the visual representation indicates the presence of a sequence repeat. In some embodiments, the nucleotide sequence is at least about 0.01, 0.1, 1, 10, or 100 megabases. In some embodiments, the nucleotide sequence is a chromosomal sequence. In some embodiments, the nucleotide sequence is DNA. In some embodiments, the nucleotide sequence is RNA. In some embodiments, the methods described herein are used to assess the quality of the nucleotide sequence produced in a nucleotide sequencing project.

“Same or similar curve pattern” or “curve patterns of the same or similar shapes” used herein include not only curve patterns (e.g. peaks and/or cluster of peaks) that have the identical shapes, but also include curve patterns (e.g. peaks or clusters of peaks) that are symmetrical, for example symmetrical across the x-axis, symmetrical across the y-axis, or 180° rotationally symmetrical. As explained in the present application, such symmetrical peaks may reflect the same sequence information in different directions within the same strand of a nucleotide sequence or the same sequence information in complementary strands in a double-stranded nucleotide.

In some embodiments, the system and process described herein may further comprise a user interface that allows input of the nucleotide sequence information, manipulation of the sequence spectra, and/or searches.

In some embodiments, the system or process may further comprises an interface for organizing annotations, for example annotations for a sequence map.

It will be appreciated that, for clarity purposes, the above description has described embodiments with reference to different functional units and/or modules. However, it will be apparent that any suitable distribution of functionality between different functional units, modules or domains may be used without detracting from the various embodiments. For example, functionality illustrated to be performed by separate modules, processors or controllers may be performed by the same module, processor or controller. Hence, references to specific functional units are only to be seen as references to suitable means for providing the described functionality, rather than indicative of a strict logical or physical structure or organization.

1. A computer-implemented method for generating a visual representation of nucleic acid data, the method comprising:
receiving a first sequence of nucleotides;
assigning values to the nucleotides of the first sequence of nucleotides to generate a first series of nucleotide values;
generating a first set of summation data for the first sequence of nucleotides using the first series of nucleotide values; and
causing a display of a visual representation of the first set of summation data.

2. The method of claim 1, wherein the first sequence of nucleotides comprises a plurality of nucleotides comprising adenine, thymine, guanine, and cytosine.

3. The method of claim 2, wherein:
each of the adenine nucleotides of the first sequence of nucleotides are assigned the same value in the first series of nucleotide values;
each of the thymine nucleotides of the first sequence of nucleotides are assigned the same value in the first series of nucleotide values;
each of the guanine nucleotides of the first sequence of nucleotides are assigned the same value in the first series of nucleotide values; and
each of the cytosine nucleotides of the first sequence of nucleotides are assigned the same value in the first series of nucleotide values.

4. The method of claim 3, wherein the values assigned to the adenine nucleotides of the first sequence of nucleotides and the values assigned to the thymine nucleotides of the first sequence of nucleotides are additive inverses, and wherein the values assigned to the guanine nucleotides of the first sequence of nucleotides and the values assigned to the cytosine nucleotides of the first sequence of nucleotides are additive inverses.

5. The method of claim 1, wherein the visual representation of the first set of summation data comprises a graph representation of the summation data.

6. The method of claim 1, wherein the first set of summation data comprises a plurality of partial sums calculated using first series of nucleotide values.

7. The method of claim 1, wherein the method further comprises:
generating a copy of at least a portion of the visual representation of the first set of summation data; and
causing a display of the copy of the at least a portion of the visual representation of the first set of summation data.

8. The method of claim 7, wherein the display of the copy comprises a reflected or rotated representation of the portion of the at least a portion of the visual representation of the first set of summation data.

9. The method of claim 1, further comprising causing a display of an annotation of featured sequences associated with a nucleotide of the first sequence of nucleotides.

10. The method of claim 1, further comprising identifying identical sections of the first set of summation data.

11. The method of claim 1, further comprising identifying symmetry between sections of the first set of summation data.

12. The method of claim 1, further comprises:
receiving a second sequence of nucleotides;
assigning values to the nucleotides of second sequence of nucleotides to generate a second series of nucleotide values;
generating a second set of summation data for the second sequence of nucleotides using the second series of nucleotide values; and
causing a display of a visual representation of the second set of summation data.

13. The method of claim 12, wherein nucleotides of the second sequence of nucleotides are assigned the same value as similar nucleotides of the first series of nucleotides.

14. The method of claim 12, further comprising identifying similar or symmetry between a section of the first set of summation data and a section of the second set of summation data.

15. A visual representation generated by the method of claim 1.

16. A method of naming a portion of a visual representation of nucleic acid data, wherein the visual representation is generated by a method comprising:
receiving a first sequence of nucleotides;
assigning values to the nucleotides of the first sequence of nucleotides to generate a first series of nucleotide values;
generating a first set of summation data for the first sequence of nucleotides using the first series of nucleotide values; and
causing a display of a visual representation of the first set of summation data.
